(19) United States
(12) Patent Application Publication
(10) Pub. No.: US 2020/0030816 A1
(43) Pub. Date: Jan. 30, 2020

(54) DEVICE FOR MAGNETIC BEAD SEPARATION AND RESUSPENSION

(71) Applicant: Dexter Magnetic Technologies, Inc., Elk Grove Village, IL (US)

(72) Inventors: Christian Kronshage, Round Lake, IL (US); Michael Schilling, Geneva, IL (US); Yakov Kanevskiy, Wheeling, IL (US)

(21) Appl. No.: 16/524,388

(22) Filed: Jul. 29, 2019

Related U.S. Application Data
(60) Provisional application No. 62/712,029, filed on Jul. 30, 2018.

(51) Int. Cl. B03C 1/03

(52) U.S. Cl. CPC B03C 1/03; B03C 2201/18

(57) ABSTRACT

An apparatus to separate and resuspend magnetic beads in a solution in a bottle includes a magnet assembly mounted on a moveable carriage. The carriage movable from a first position wherein the magnet assembly is proximate a bottle disposed on a rotating base to a second position wherein the magnet assembly is distal from the base. The magnet assembly is configured to impart a magnetic field amplitude gradient in the bottle when the bottle is proximate to the magnet assembly.

### CROSS REFERENCE TO RELATED APPLICATIONS

Priority is claimed from U.S. Provisional Application No. 62/712,029 filed on Jul. 30, 2018. The foregoing application is incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of magnetic devices used to mix and separate magnetic particles disposed in a liquid.

The use of high gradient magnetic fields for the separation of target particles is commonplace in the fields of biology, biotechnology, and bio-medicine. Target particles, comprising entities such as proteins and the like, may be separated from a solution by the use of magnetic beads.

During the manufacturing process, these solutions are stored in reagent bottles. The solutions undergo several purification cycles before they are ready for individual packaging. These cycles consist of separating the magnetic beads to the side of the reagent bottle, aspirating out supernatant, and dispensing more wash solution. The magnetic beads then need to be resuspended in the newly added solution, which prior to the present disclosure includes removing the bottle from the magnetic separator and placing it on a different device, such as a bottle roller, vortexer, or stir plate. This process is time consuming since it may take several of these cycles to process the solution.

An apparatus according to the present disclosure may address these issues by providing a single device that can separate and resuspend magnetic beads in a reagent bottle without removal of reagent bottle from the apparatus.

### SUMMARY

An apparatus to separate and resuspend magnetic beads in a solution in a bottle according to one aspect of the disclosure includes a magnet assembly mounted on a moveable carriage. The carriage is movable from a first position wherein the magnet assembly is proximate a bottle disposed on a rotating base, to a second position wherein the magnet assembly is disposed away from the bottle. The magnet assembly is configured to impart a magnetic field amplitude gradient in the bottle when the bottle is proximate to the magnet assembly.

In some embodiments, the carriage may move vertically and/or horizontally to optimize separation and resuspension of the magnetic beads.

In some embodiments, the magnet assembly comprises a half toroid.

In some embodiments, the magnet assembly comprises one of a hallbach magnet assembly, a quadrature magnet assembly, an unbalanced magnet assembly, or a full toroid magnet assembly.

In some embodiments, the magnet assembly may comprise one or more electromagnets.

Some embodiments further comprise a controller in signal communication with a motor arranged to move the carriage, the controller configured to automate movement of the carriage.

In some embodiments, the automated movement of the carriage is controllable to optimize a carriage motion profile for use with a variety of bead solutions.

In some embodiments. the apparatus is integrated into an automated liquid handling system.

A method for separating and resuspending magnetic particles in a bottle having liquid therein according to another aspect of the disclosure includes disposing the bottle proximate a magnet, the magnet configured to induce a magnetic field having an amplitude gradient in the bottle, and rotating the bottle to separate the magnetic particles from the liquid.

Some embodiments further comprise moving the bottle away from the magnet while rotating the bottle to resuspend the magnetic particles in the liquid.

In some embodiments, the moving is performed automatically.

In some embodiments, the moving is performed along a line, a rate of the moving chosen to correspond to at least one of magnetic particle size distribution, magnetic particle distribution and a viscosity of the liquid.

### BRIEF DESCRIPTION OF THE DRAWINGS

FIG. 1 shows an example embodiment of an apparatus according to the present disclosure.

FIG. 2 shows the example embodiment of FIG. 1 wherein a carriage is moved away from a reagent bottle and a clamp is opened above the reagent bottle.

### DETAILED DESCRIPTION

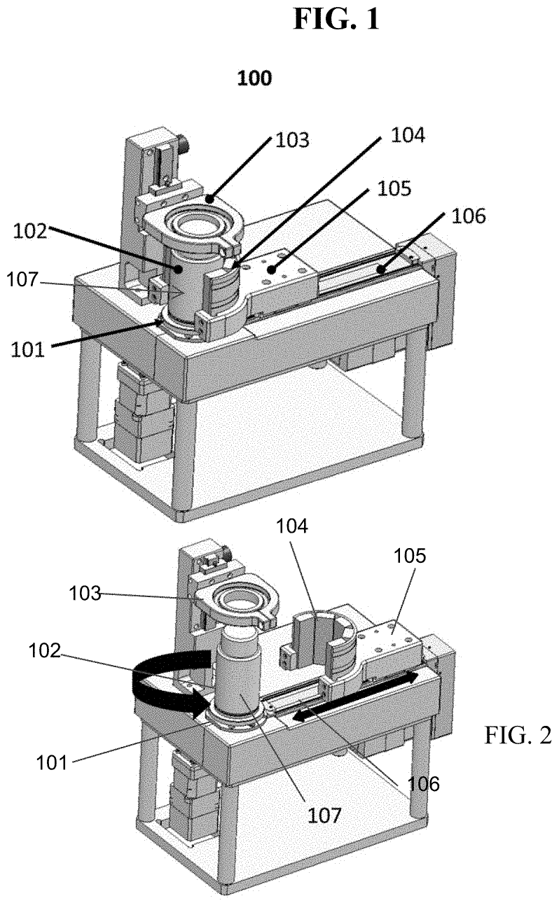

An example embodiment of an apparatus according to the present disclosure is shown in FIG. 1. The apparatus (100) may comprise a rotating base (101), which can hold a bottle (102) containing magnetic beads (not shown separately). The bottle (102) is held in place by a clamp assembly (103). A magnet assembly (104) which in the present embodiment may be a half-toroidal magnet assembly, is mounted to a carriage (105). The carriage (105) can move axially (linearly) along a rail (106). Magnetic force from the magnet assembly (104) may be focused toward the center axis (not shown separately) of the half-toroid magnet assembly (104) so that it imparts a magnetic field gradient onto the magnetic beads when the magnet assembly (104) comes in contact with the bottle (102), and causes the magnetic beads to separate. For purposes of defining the scope of the present disclosure, the magnet assembly (104) may have the property of imparting a static magnetic field with an amplitude gradient inside the bottle (102) when the magnet assembly (104) contacts or is proximate to the bottle (102). Moving the carriage (105) and therefore the magnet assembly (104) back and forth along the rail (106), while rotating the bottle (102) causes the magnetic beads to resuspend in a solution (107) within the bottle (102),

Some embodiments may comprise different forms for the magnet assembly (104), for example, a Halbach magnet assembly, a quadrature magnet assembly, an unbalanced magnet assembly, or a full toroid magnet assembly.

In some embodiments, movement of the carriage (105) is automated. For example a motor (not shown separately) such as an electric motor may cause the carriage (105) to move along the rail (106). Another motor (not shown separately) such as an electric motor may be used to rotate the base (101). A controller (not shown separately), such as a microprocessor, programmable logic controller, field programmable gate array or microcomputer may be in signal communication with one or both motors to effect automated rotation of the bottle (102) and motion of the carriage (105) to cause settling and resuspension of the magnetic beads (not shown separately) in the bottle (102).

In some embodiments, automated movement of the carriage (105) is controllable by the controller (not shown) to optimize a carriage motion profile for use with various bead solutions, for example, different particle size distribution and concentrations of beads in liquids of different viscosities.

In some embodiments, the automated, electronically controlled magnet assembly (104) is integrated into an automated liquid handling system.

The movement of the magnet assembly (104) proximate to or into contact with the bottle (102) imparts a magnetic field gradient on the beads in the solution, pulling them to the side of the bottle (102).

The movement of the magnet assembly (104) back and forth, along the rail (105) with the rotation of the bottle (102), imparts a magnetic field gradient on the beads, pulling them off the side of the bottle (102) and back into suspension in the solution.

FIG. 2 shows the clamp assembly (103) lifted above the top of the bottle (102) so that the bottle (102) may be inserted onto or removed from the rotating base (101). FIG. 2 also shows the magnet assembly (104) moved away from the bottle (102) by movement of the carriage (105) along the rail (106).

The apparatus (100) may be self-contained and can fit on a laboratory bench, for use in solution processing.

The apparatus (100) can also be mounted to the deck of an automated liquid handling system for use in automated assays.

The apparatus (100) can be modified to accommodate a variety of bottle types and sizes used in the Life Sciences field.

Although only a few example embodiments have been described in detail above, those skilled in the art will readily appreciate that many modifications are possible in the examples. Accordingly, all such modifications are intended to be included within the scope of this disclosure as defined in the following claims.

What is claimed is:

1. An apparatus to separate and resuspend magnetic beads in a solution in a bottle, comprising:
a magnet assembly mounted on a moveable carriage, the carriage movable from a first position wherein the magnet assembly is proximate a bottle disposed on a rotating base, the carriage movable to a second position wherein the magnet assembly moves away from the bottle, the magnet assembly configured to impart a magnetic field amplitude gradient in the bottle when the bottle is proximate to the magnet assembly.

2. The apparatus of claim 1 wherein the magnet assembly comprises a half toroid.

3. The apparatus of claim 1 wherein the magnet assembly comprises one of a hallbach magnet assembly, a quadrature magnet assembly, an unbalanced magnet assembly, or a full toroid magnet assembly.

4. The apparatus of claim 1, further comprising a controller in signal communication with a motor arranged to move the carriage, the controller configured to automate movement of the carriage.

5. The apparatus in claim 4, whereby the automated movement of the carriage is controllable to optimize a carriage motion profile for use with a variety of bead solutions.

6. The apparatus in claim 5 the apparatus is integrated into an automated liquid handling system.

7. The apparatus of claim 1 wherein the magnet assembly comprises at least one electromagnet.

8. The apparatus of claim 1 wherein the carriage is movable in a vertical and/or horizontal direction.

9. A method for separating and resuspending magnetic particles in a bottle having liquid therein, comprising:
disposing the bottle proximate a magnet, the magnet configured to induce a magnetic field having an amplitude gradient in the bottle; and
rotating the bottle to separate the magnetic particles from the liquid.

10. The method of claim 7 further comprising:
moving the bottle away from the magnet while rotating the bottle to resuspend the magnetic particles in the liquid.

11. The method of claim 8 wherein the moving is performed along a line, a rate of the moving chosen to correspond to at least one of magnetic particle size distribution, magnetic particle distribution and a viscosity of the liquid.

12. The method of claim 8 wherein the moving is performed automatically.
